(19) United States
(12) Patent Application Publication
(10) Pub. No.: US 2007/0055688 A1
(43) Pub. Date: Mar. 8, 2007

(54) Automatic report generation

(75) Inventor: Donald E. Blattner, Valrico, FL (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/221,960

(22) Filed: Sep. 8, 2005

(51) Int. Cl. G06F 7/00

(52) U.S. Cl. 707/102

(57) ABSTRACT

The present invention provides a computer-implemented method, system, and program product for automatically generating reports. Specifically, the present invention allows report data about project tasks and scheduling to be mapped from a first application format (e.g., Microsoft Project) to a spreadsheet format using a data translation map. Once mapped to the spreadsheet format, the present invention then allows a set of predefined reports containing the report data to be generated. As has been described in greater detail above, the present invention also provides for data/report selection, formatting, filtering, sorting, etc., based on dialog input received from a user.

### BACKGROUND OF THE INVENTION

1. Field of the Invention

The present invention generally relates to project data management. Specifically, the present invention allows automatic report generation of project data that can be viewed by all members of a project team.

2. Related Art

As computer infrastructures and applications become more sophisticated, project task management and scheduling is being performed on a computerized level with increasing frequency. One example of a tool that is currently used for these functions is Microsoft Project, which is commercially available from Microsoft, Corp. of Redmond, Wash. While Microsoft Project is a good project scheduling tool, it is not ideal for communicating information to the majority of the project team. Specifically, current implementations require all users who desire to access the project scheduling data to have the Microsoft Project software installed on their machines, or to have the project manager manually generate and distribute reports.

Given that a single license for Microsoft Project can cost several hundred dollars, access to the data has been traditionally limited to project managers and the like as opposed to all project team members. In addition, Microsoft Project provides little flexibility in highlighting information within the context of an overall project plan. In most instances one of two things occur: (1) the majority of the project team is limited to a very few reports (sometimes one report) that the project manager prints and distributes. In this instance, the team members cannot alter views, customize reports, filter or manipulate data as they could if the data were in a spreadsheet; or (2) the project manager spends many hours manually extracting Microsoft Project data to spreadsheets, summarizing, sorting, formatting, and highlighting key project information within the context of the overall project plan. As such, time that could be spent managing project deadlines, resources, and issues is instead used to perform manual tasks.

In view of the foregoing, there exists a need for a system that is capable of taking data in one application format (e.g., Microsoft Project) and mapping/exporting it into a second application format (e.g., a spreadsheet format). A further need exists for a set of reports to be automatically generated in the second application format based on input from a user.

### SUMMARY OF THE INVENTION

In general, the present invention provides a computer-implemented method, system, and program product for automatically generating reports. Specifically, the present invention allows report data about project tasks and schedules to be mapped from a first application format (e.g., Microsoft Project) to a spreadsheet format using a data translation map. Once mapped to the spreadsheet format, the present invention then allows a set of predefined reports containing the report data to be generated. As will be described in greater detail below, under the present invention, data/report selection, formatting, filtering, sorting, etc., is performed based on dialog input received from a user.

A first aspect of the present invention provides a computer-implemented method for automatically generating reports, comprising: providing a data file that includes report data in a first application format; mapping the report data into a spreadsheet format using a data translation map; and generating a set of predefined reports containing the report data in the spreadsheet format based on dialog input from a user.

A second aspect of the present invention provides a system for automatically generating reports, comprising: a system for obtaining a data file that includes report data in a first application format; a system for mapping the report data into a spreadsheet format using a data translation map; and a system for generating a set of predefined reports containing the report data in the spreadsheet format based on dialog input from a user.

A third aspect of the present invention provides a program product stored on a computer readable medium for automatically generating reports, the computer readable medium comprising program code for causing a computer system to perform the following steps: obtaining a data file that includes report data in a first application format; mapping the report data into a spreadsheet format using a data translation map; and generating a set of predefined reports containing the report data in the spreadsheet format based on dialog input from a user.

A fourth aspect of the present invention provides a method for deploying an application for automatically generating reports, comprising: providing a computer infrastructure being operable to: obtain a data file that includes report data in a first application format; map the report data into a spreadsheet format using a data translation map; and generate a set of predefined reports containing the report data in the spreadsheet format based on dialog input from a user.

A fifth aspect of the present invention provides computer software embodied in a propagated signal for automatically generating reports, the computer software comprising instructions for causing a computer system to perform the following steps: obtaining a data file that includes report data in a first application format; mapping the report data into a spreadsheet format using a data translation map; and generating a set of predefined reports containing the report data in the spreadsheet format based on dialog input from a user.

Therefore, the present invention provides a computer-implemented method, system, and program product for automatically generating reports.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for automatically generating reports according to the present invention.

FIGS. 2A-E show illustrative dialog boxes/screens for user input according to the present invention.

FIG. 3 shows an illustrative predefined report according to the present invention.

FIG. 4 shows a more specific computerized implementation of the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes, the Detailed Description of the Invention will have the following sections;

I. General Description

II. Illustrative Embodiment

III. Predefined Reports

IV. Computerized Implementation

I. General Description

As indicated above, the present invention provides a computer-implemented method, system, and program product for automatically generating reports. Specifically, the present invention allows report data about project tasks and scheduling to be mapped from a first application format (e.g., Microsoft Project) to a spreadsheet format using a data translation map. Once mapped to the spreadsheet format, the present invention then allows a set of predefined reports containing the report data to be generated. As will be described in greater detail below, the present invention also provides for data/report selection, formatting, filtering, sorting, generation of new data derived from processing of existing data, etc., based on dialog input received from a user.

II. Illustrative Embodiment

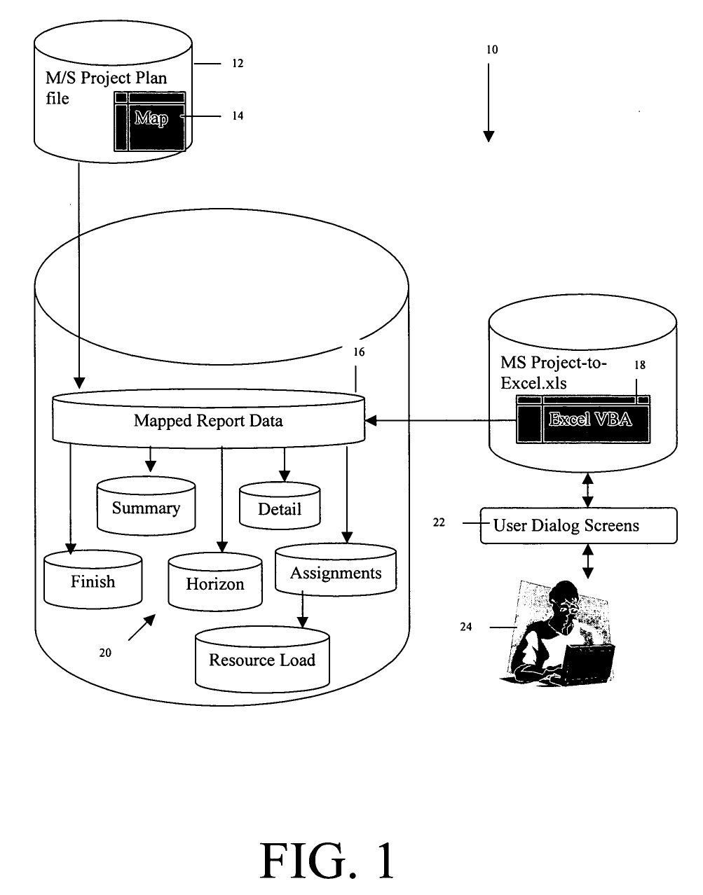

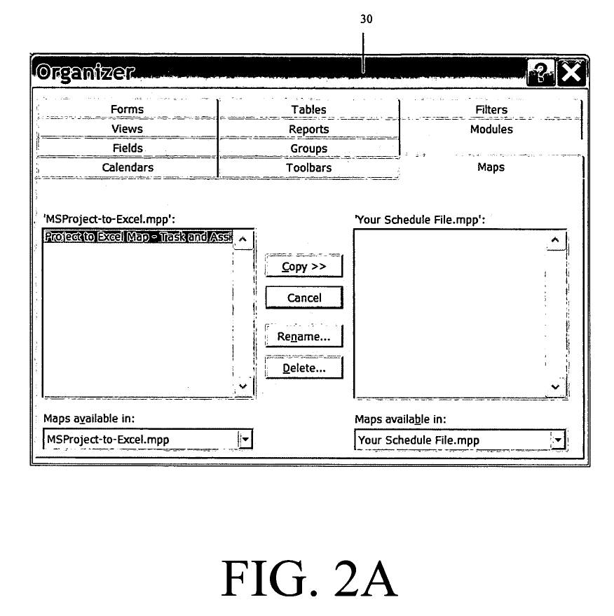

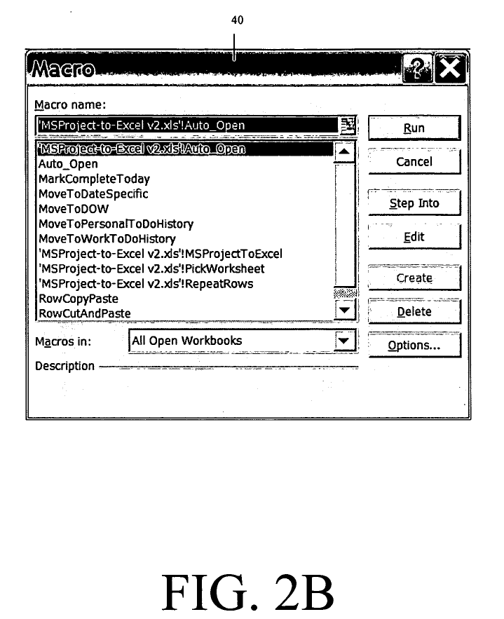

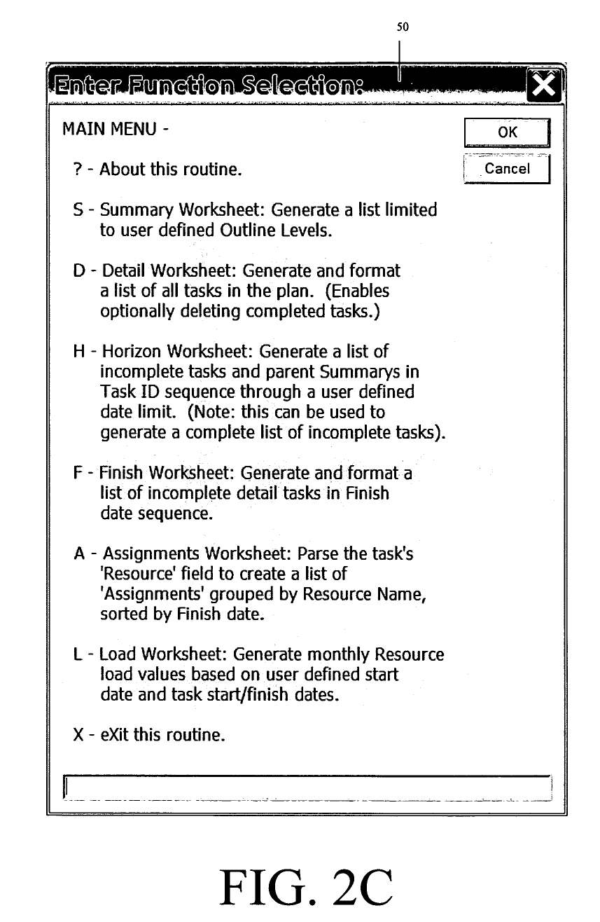

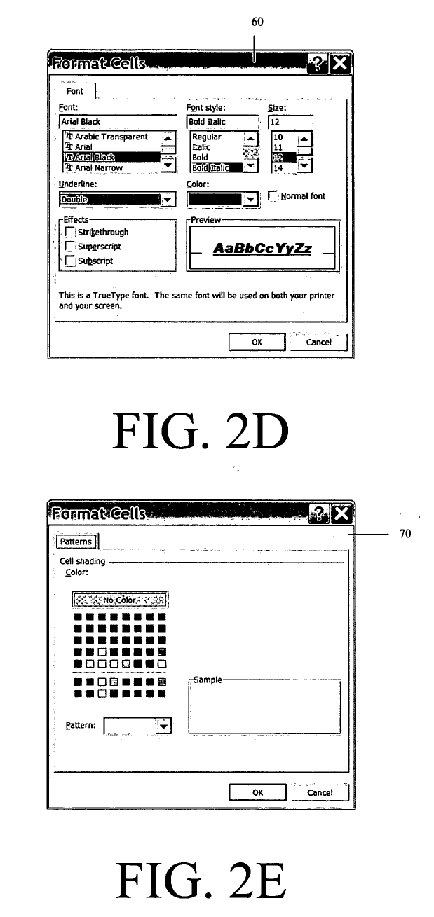

FIGS. 1 and 2A-E will be used to describe an illustrative embodiment of the present invention. In this example, report data will be mapped/converted from a Microsoft Project application format into a Microsoft Excel application format. It should be understood, however, that the present invention is not limited to these application formats. For example, the present invention could be used to convert report data from a Microsoft Project application format to any type of spreadsheet application format.

In any event, referring now to FIG. 1, an illustrative system 10 according to one embodiment the present invention is shown. In this illustrative embodiment, project data 12 (shown as M/S Project Plan file) is provided. In general, project data 12 includes tasks and task schedules for one or more projects to be completed by one or more users/individuals. To this extent, project data 12 can specify specific tasks, users assigned thereto, a time-table for completion of the tasks, and other data. Regardless, using data translation map 14, project data 12 will be mapped to Excel application format. The result is shown in FIG. 1 as mapped report data 16. This data is used to create all of the reports/worksheets 20. In general, mapped report data 16 minimally contains the following fields (e.g., in any sequence): (1) ID (Task ID) Predecessors; (2) Name (or Task Name); (3) Duration; (4) Start Date (5) Finish Date; (6) Actual Work; (7) Scheduled Work (also referred to as “Work” or “Remaining Work”); (8) % Work Complete; (9) Resource Names; (10) Outline Level (e.g., for report formatting); (11) Summary (e.g., for report formatting); and (12) Milestone (e.g., for report required formatting). In addition, mapped report data 16 can include fields that can appear as data fields/columns in the reports 20, but are not required; e.g., (1) Critical Path; (2) Slack; and (3) Baseline Fields.

Once mapped report data 16 is established, an Excel VBA program 18 provided under the present invention will be used to generate a set (e.g., one or more) of predefined reports 20. As will be further described below, report generation under the present invention is based on the code of Excel VBA 18 as well as on input from user received via dialog screens/boxes 22 (also referred to herein as dialog input). Specific examples of dialog screens 22 will be shown below.

Although specific reports are programmed via VBA program 18, options offered by user dialog screens 22 provide flexible formatting options to support individual needs. The standard and optional formatting include, among other things: (1) creation of separate reports 20 to display and highlight data for different purposes; (2) record selection - inclusion and deletion; (3) data sorting and/or filtering (e.g., based on due dates, user attributes such as names, roles, task percent complete, etc.); (4) default and user controlled font sizing, italicizing, bolding, and underlining based upon the task level and/or the task being a detail or summary task; date formatting (e.g., Microsoft Project exports a date in date and time format such as “6/30/2005 5:00:00 PM”, and this routine reformats to mm/dd/yy format such as “6/30/05”); (5) default column sequencing and column width setting (e.g., the column width setting results in a report 20 that is ready to print on 8½×11 size paper); (6) programmed application of word wrap to data that may extend beyond one physical line; (7) default and user controlled background coloring; (8) default indenting of tasks based upon the task “Outline Level” as defined in the source project plan data 12; (9) default bolding of Summary tasks; (10) default and user controlled page breaks and row border marking; (11) creation of report titles, column headings and page footers; and (12) application of spreadsheet controls such as freeze panes and column header rows repeat.

As further shown in FIG. 1, reports 20 can include the following reports;

Summary—a report limited to the highest level tasks as specified by the user via dialog screens 22. This is typically the highest two or three levels to provide a shorter summary version of the project schedule than can be understood without a complete detailed schedule.

Detail—the complete schedule in a task ID sequence with indenting based upon Outline Level and bolding of Summary Tasks. Additionally special font and background effects can be applied to tasks in a user specified date range or to completed tasks.

Horizon—a list of incomplete tasks (completed tasks are excluded) that have Finish date falling within a limited future horizon (typically two weeks or a time period specified via dialog screens 22). This report provides a time focused filter to work that needs to be completed in the near term or a user specified term.

Finish—a list of tasks in Finish Date sequence. A “visual boundary” option specified via dialog screens 22 allows user 24 to put visual separation between weeks or months or at any dates of the user 24's choice.

Assignments—a report that is created by parsing the “Resource” field of tasks such that a task row is created for every resource. The task/resource records are grouped by Resource and sorted by Finish date to provide a Finish date sequenced list of each Resource's tasks. (e.g., Detail tasks with no resource result in a task/resource record with the Resource name of “Unassigned”). This report also requires the resource parsing (as described below) to generate discrete individual assignments for each resource when multiple resources are assigned to a single task.

Resource Load—the “Assignments” report expanded to include distribution of remaining work to monthly “buckets” to see monthly load on each resource. This report includes twelve monthly intervals or buckets and a “Months Beyond” interval/bucket for the hours. Totals per Resource are included for Actual hours, Remaining hours, the twelve monthly intervals, and the Months Beyond interval.

As indicated above, the report generation of the present invention is primarily driven based on VBA program 18 and input provided by user 24 via dialog screens 22. FIGS. 2A-E will be used to illustrate some of these processes and dialog screens 22. It should be understood in advance that the dialog screens shown in FIGS. 2A-E are not intended to be limiting.

In a typical embodiment, data translation map 14 can be copied from a “MSProject-to-Excel.mpp” file into Microsoft Project schedule file(s). Although the present invention could execute the mapping in a schedule file by accessing the “MSProject-to-Excel.mpp” file's data mapping (e.g., as long as that file was open) each time access was desired, having a copy in a schedule file makes the process simpler. To this extent, an “Organizer” dialog can be used to copy data translation map 14 from one project plan file to another through menus and dialog screen selections.

Referring to FIGS. 1 and 2A, an organizer dialog screen 30 for copying data translation map 14 to user 24's schedule is shown. Specifically, to copy data translation map 14 to user 24's schedule, with the “MSProject-to-Excel.mpp” schedule file and the target project plan data 12 open (e.g., this is the file user 24 should want to copy the data translation map 14 into), the below steps will be executed:

(1) Click on menu item: “Tools”

(2) Select from drop-down list: “Organizer”

(3) Click on tab: “Maps”

(4) Ensure the “From” file (left side) is “MSProject-to-Excel.mpp”

(5) Ensure the “To” file (right side) is your target schedule file

(6) If the “MSProject-to-Excel.mpp” file has multiple maps then select the correct one

(7) Click on: “Copy>>”

After this is done and the schedule file is saved, data translation map 14 will be available and the “MSProject-to-Excel.mpp” file need not be opened by user 24 every future time he/she desires to use data translation map 14.

In general, data translation map 14 defines the project plan data 12 to be mapped (e.g., also referred to as “exported”). Regardless of columns/fields displayed, filters applied to current Microsoft Project view, or summary task groups collapsed, all tasks in the schedule and all fields specified in data translation map 14 will be mapped/exported. Although a filter can be applied in Microsoft Project exporting, data translation map 14 used in this illustrative example specifies the “All Tasks” filter.

In any event, once data translation map 14 has been copied into the schedule file as described in conjunction with FIG. 2A, user 24 can use the data mapping definition and mapped report data 16 repeatedly (e.g., weekly) to generate an Excel file for report generation. The detailed steps followed by user 24 are as follows:

(1) Select—File/Save As/specify new path and file name

(2) Enter the path where he/she wants to save the file in the “Save in” text box

(3) Enter “Save as Type: Microsoft Excel Workbook (*.xls)”

(4) Click on “Save”

(5) Export Mapping Dialog box appears

(6) Select the data map name “MS Project to Excel”

(7) Click on “Save”

Once mapped report data 16 is provided, VBA program 18 will be used to actually generate reports 20. As indicated above, report selection, generation, formatting and many other features (e.g., report sorting, filtering, etc.) of the present invention are provided by hard coding within VBA program 18 and input from user 24 received via dialog screens 22. As such, shown below are illustrative steps that can be followed for selecting and generating specific reports.

(1) Open the saved Excel file containing the just mapped report data 16

(2) Open the “MSProject-to-Excel.xls” file containing the report generating and formatting VBA program 18. During the open process, user 24 may be asked to enable or disable macros. When asked, user 24 will select click on the “Enable Macros” selection.

(3) In the exported data Excel file, user 24 will then execute the menu path: Tools/Macro/Macros

(4) At this point a list of macros available in all open Excel files will be displayed.

Referring to FIG. 2B, an illustrative dialog screen 40 showing available macros is depicted. In general, macros in the current file will be displayed with no prefix, while macros from other files (including the “MSProject-to-Excel.mpp” file) will be displayed with the file name, an exclamation mark (“!”), and the macro name. The process will continue with the following steps:

(5) Click on the entry: ‘MSProject-to-Excel’!MSProjectToExcel—this will invoke the main menu used to generate the reports. At this point the illustrative dialog screen 50 shown in FIG. 2C will be displayed. When presented with dialog screen 50, user 24 will:

(6) Enter the letter corresponding to the specific report he/she wishes to generate and click <Ok> or just press the <Enter> key. This will cause VBA program 18 of FIG. 1 to utilize mapped report data 16 contained in the saved Excel file and generate the specifically selected report. Generally, in this step, user 24 may enter upper or lower case letters to invoke the selection. VBA program 18 is programmed to work with either.

In addition, during the execution of the individual reports, user 24 can be further prompted to enter options involving task selection and formatting. Some of these options use the dialog screens such as dialog screens 60 and 70 of FIGS. 2D-E. As can be seen, dialog screens 60 and 70 allow for various formatting of reports 20 such as font type and size, font color, font effects and nature (e.g., boldface, underline, etc.). Based on this input, reports 20 will be automatically formatted when generated.

It should be understood that various other features (although not depicted in illustrative dialog screens herein) are provided under the present invention. Such features will be discussed in greater detail below. Examples of such features include the following;

Report Sorting—reports 20 can be sorted based on data attributes (e.g., names, dates, etc.).

Report Filtering—reports can be filtered based on filters (e.g., date ranges, percent complete, etc.) input by user via dialog screens.

Intelligent Data Column Recognition—data can be received in a variety of column sequences. The code searches the contents of rows it recognizes as column heading rows and associates the data to field types. For example, the Resource data might be contained in column “C”, column “F”, column “X”, etc. The program examines the column heading rows looking for “Resource”, “Resources”, or “Resource Names” and when it finds this it identifies the column as one containing the names of resources. The program code then works with the Resource column as opposed to working with column “C”, “F”, or column “X”—it works with the meaning of the data as opposed to the physical address of the data.

Automated Column Sequencing—the code sequences columns in a defined order regardless of the order in which they are received. The program uses the “Intelligent Data Column Recognition” functionality to perform column sequencing based upon the meaning of the data as opposed to hard coded column addresses. This could not be automated merely through the Excel Macro Record feature—it requires code to make decisions.

Intelligent Data Row Sorting—for the various reports the program determines the boundaries of the data so as to not include heading rows and not include rows beyond the end of the data. The determination of end of data is not as straight forward as one might think since one or more blank rows may exist within the file and therefore a single blank row is not a true indication of the end of data. The program determines end of data by searching for a number of consecutive blank rows and then the program recognizes the last data row to be the last row immediately preceding the consecutive set of blank rows. Without this feature the person would not be able to record and reapply any previous sorts since the number of rows may have changed and Excel Macro Recording records the row numbers rather than the logical end of file. The program also uses the “Intelligent Data Column Recognition” functionality to perform sorts based upon the meaning of the data as opposed to hard coded column addresses. The sorting can be two to three levels for each report.

Data Selection (Inclusion and Exclusion)—this code programmatically makes decisions on records to include or exclude in the reports based upon coded logic and user responses via dialog boxes. Some decisions involve comparisons of data between multiple records, other decisions relate user dialog responses to the data in making decisions.

Automated Task Indenting and Summary Activity Bolding—the program will indent sub-ordinate tasks under parent tasks providing a hierarchical view. For example if a high level Activity consists of four Tasks and some of these Tasks consist of Sub-tasks then this program will indent the Tasks under the Activity and further indent the Sub-tasks under the tasks. This provides for better understanding of the structure of the schedule.

User Interface Via User Dialogs—the program makes significant use of User Dialog boxes to make the program easier to run, more flexible and more user-friendly. These User Dialog boxes are pop-up screens or panels that ask questions and provide for user input, then execute program code based upon program logic. User Dialog boxes can not be Macro Recorded—they require programming.

Visual Separators and Page Breaks—based upon user responses to User Dialog boxes, the program will insert rows of black background (black rows) to provide visual separation when key data values change. This code also programmatically inserts page breaks for printing—again, something Excel Macro Record fails to do with any logic.

Intelligent Formatting—the program provides bolding, underlining, word wrap, font coloring, background coloring, date reformatting, etc., programmatically applied based upon the logic coded in the program and responses to user dialogs.

Generates Multiple Reports Based Upon One Exported File—the program operates from the export of a single worksheet into the spreadsheet to then generate six distinct worksheets/reports.

Resource Parsing/Splitting to Multiple Records—in Microsoft Project a single task can have multiple resources assigned. Excel cannot provide a report of tasks assigned to a person since tasks may have multiple people assigned and therefore need to be replicated to create several duplicate tasks—duplicate with respect to task descriptions, dates, etc., except that each task will have a different single resource (for example, a task with 5 resources would require that 5 tasks be generated with only one resource in each of the 5 tasks). This can be performed only with code designed to do this. This program further takes the tasks (original and generated), sorts them, groups them providing collapsible and expandable views, and adds a highlighted and formatted summary line for each resource. This parsing to generate multiple records is impossible without programming.

III. Predefined Reports

FIG. 1 shows several specific predefined reports 20 that are provided under the present invention. As demonstrated above, report generation and formatting is dialog driven and is easily invoked from the exported file using Excel menus. The main menu and the formatting option dialog boxes provide good explanations of available choices. Although specific reports are programmed, options offered by user dialogs provide flexible formatting options to support individual needs. The standard and optional formatting includes, among other things: (1) creation of separate reports to display and highlight data for different purposes; (2) record selection—inclusion and deletion; (3) default data sorting; (4) default and user controlled font sizing, italicizing, bolding, and underlining based upon the task level and/or the task being a detail or summary task; (5) date formatting Microsoft Project exports a date in date and time format such as “6/30/2005 5:00:00 PM”, and this routine reformats to mm/dd/yy format such as “6/30/05”); (6) default column sequencing and column width setting (the column width setting results in a worksheet/report which is ready to print on 8½×11 size paper); (7) programmed application of word wrap to data that may extend beyond one physical line; (8) default and user controlled background coloring; (9) default indenting of tasks based upon the task “Outline Level” as defined in the source Project plan; (10) default bolding of Summary tasks; (11) default and user controlled page breaks and row border marking; (12) creation of report titles, column headings and page footers; (13) application of spreadsheet control such as freeze panes and rows repeat; etc.

The subsections below will describe some of the features of the predefined reports discussed above:

A. Horizon Report

Purpose: To provide a focus limited view of incomplete tasks—enabling focus on late tasks (late compared to plan) and tasks with near term Finish dates. This particular report can be used successfully in weekly team status and planning meetings—providing visibility to past due tasks and to tasks due in the near term.

Selection Options: Detail tasks are automatically limited to incomplete status only; and any parent summary task that is complete will also be excluded. Additionally, a dialog box enables the user to specify a future date to further limit tasks displayed. For example, if the user specifies 6/30 as the limiting date then any detail tasks with Finish dates beyond 6/30 will not be included in this report. Parent summary tasks of included detail tasks will also be included even though they may have a Finish date outside the user specified limit (e.g., this will happen when a parent Summary task has detail tasks that are both within and beyond the limit). For example if the limit is 6/30 and a Summary task has two subordinate incomplete detail tasks—one with a Finish date of 6/25 and one with a Finish date of 7/12—then the Summary task will have a Finish date of 7/12 but will be included in the report anyway because it is the parent of a detail task which is included. One choice that is especially effective is to choose the week ending date of the week following the current week. For example, if a project review is being conducted on a Tuesday or Wednesday, a report can be produced that is limited to incomplete tasks due through the Friday of the following week.

Sorting and Grouping: The report remains in Task ID sequence.

Formatting and Options: One option that is available is to format tasks at Outline Levels 1 and 2 and/or to add a border above the start of Outline Level 2. Another option is to provide a Page Break with each Outline Level 1 (other than the first occurrence. Another option is to format detail tasks (the tasks that “hold the work”). Yet another option is to provide formatting and/or add text to tasks with a Finish date that is less than or equal to a user specified date (e.g., add “Late” to any task with Finish date less than the current date).

B. Summary Report

Purpose: To provide a high level, summary view of the schedule.

Selection Options: Select the number of levels based on the “Outline Level” field. (Two or three levels generally work well).

Sorting and Grouping: Sort is by Task ID. There is no grouping.

Formatting and Options: Bolding of Summary tasks, indenting based on Outline Level. Word wrap of task name and dates formatting are applied. If the Outline Level specified is 2 or greater then the user has options to apply font and color background formatting to Outline Levels 1 and 2. If the Outline Level specified is 2 or greater then the user will have options to apply borders to Outline levels 1 and 2, and page breaks to Outline Level 1.

C. Detail Report

Purpose: To provide a “standard” view of the entire project schedule. The “standard” view is similar to a view in Microsoft Project that bolding of Summary tasks and indenting based on Outline Level.

Selection Options: All tasks/activities are included.

Sorting and Grouping: Tasks remain in Task ID sequence.

Formatting and Options: Specify and highlight tasks with “Finish” in a specific period. This can be used to highlight past due tasks or tasks within a period (e.g., next two weeks). Formatting can be font or background formatting. A default option of yellow background is offered. Apply special formatting to completed tasks. Formatting can be font or background formatting. A default option of gray background can be offered.

D. Finish Report

Purpose: To display incomplete tasks in Finish date (due date) sequence to enable focus on late tasks and near term tasks.

Selection Options: Incomplete detail tasks and any incomplete Milestones that have resources assigned. Summary tasks and Milestones that have no resources assigned are excluded.

Sorting and Grouping: Sorted by Finish date, Task ID. No grouping.

Formatting and Options: The user may highlight a specific period (highlight via font or background). The user has the option to insert a narrow, totally black row after a date or any number of dates. This provides visual boundaries between weeks or months or milestone dates or any date based position the user chooses.

E. Assignments Report

Purpose: This report is different than all the others in that the report is oriented to group by assigned Resource rather than following the project schedule organization or being date driven. For every task record the “Resource” field is examined and parsed so as to create an individual task record for each resource (e.g., if there are five resources assigned then five task records will be created with each one containing only one of the resources in the group). Project schedules are used differently by different project managers and in different ways. Microsoft Project supports recording and tracking both a “resource” percent complete on a task and the “task” percent complete. Microsoft Project maintains Assignment records and if the project were maintained at this level of detail (e.g., entering effort hours and percent complete for each resource assigned to a task rather than merely entering Task % complete) then you would want to use a MICROSOFT Project export of Assignments data rather than using this data. This module takes the percent task complete and applies that same percentage to every resource/task record generated by the parsing routine. (The file that comes with this documentation includes the “AssignmentSource” export mapping for Assignment data. There is no programming associated with this but the data will be generated automatically with the task data and available for your use.) This report enables any project team member to view all tasks assigned to her/him and to see them in Finish date order.

Selection Options: Summary rows are excluded. Milestones that have no resources assigned are excluded. The user has the option to exclude completed tasks.

Sorting and Grouping: This is grouped by Resource name and sorted within resource by Finish date.

Formatting and Options: Detail tasks with no assigned resources have the resource “Unassigned” generated. Resource detail data and total rows are expandable/collapsible. Highlight in gray or via ‘Format Cells’ dialog box assignments from completed tasks (can also delete completed tasks/assignments). Option exists to highlight tasks with a certain Finish date in a specific period.

F. Resource Load Report

Purpose: This report is different than all the others in that it is generated from the “Assignments” worksheet rather than the “Task Source” worksheet (although “Assignments” is generated from “Task Source” and therefore this report is indirectly generated from that data also). This worksheet/report expands the Assignments data to show task loads distributed to monthly “buckets” for each Assignment. Total of Actual hours, Remaining hours, Monthly hours and a “Months Beyond” hours total are provided at the resource level. The totals generated are a “rough cut approximate” total based upon a distribution of hours. “Resource Load” assumes that all days of a month are working days—it is not “aware’ of Saturdays, Sundays or Holidays (e.g., it is also not aware of “contours”—Microsoft Project's structuring of hours disbursed in an uneven manner across a task start/finish period). This routine works with a rolling twelve-month period, with the first month being based upon a user enter start date. This module computes the number of days in a task that fall within each calendar month of a rolling twelve-month period. It then allocates Remaining Hours to each of the thirteen periods (twelve months+‘Beyond’) according to what percent of total days are within each period.

The program makes some date adjustments for computing purposes (the actual dates displayed do not change): (1) If the task completion date exceeds the rolling twelve month limit then excess hours are rolled into a 13^{th} period labeled “Months Beyond.” (2) If the task start date is less than the user entered start date (the first date after the last actual time reporting) then the start date is adjusted—for computing purposes only—to the user entered start date. (3) If the entire task is scheduled to be completed prior to the user entered start date then the task start and finish dates are adjusted—for computing purposes only—to the start date.

The following represents a Resource Load Computation Example;

Assume a Task with 100 Remaining Work Hours,

Task Start=2/10, Task Finish=4/14,

user entered Period Start Date=2/18.” The computation would be:
February computed days=11 (Feb 18 through Feb 28 inclusive)
   March computed days=31
   April computed days=14

February hours=11/(11+31+14)×100 hours=19.6%×100=19.6 hours

March hours=31/(11+31+14)×100 hours=53.6%×100=55.4 hours

April hours=14/(11+31+14)×100 hours=26.8%×100=25.0 hours
Total=100.0 hours

The program also requests hour minimums and hour maximums which it uses in highlighting potential over and under allocations. For example, if resources are targeted to be used (work assigned) an average of 160 hours a month, the user can enter responses to the prompts to indicate/highlight monthly totals which are less than 140 hours or more than 180 hours. Two sets of minimum/maximum parameters are requested, one set for months 2-12 and a separate set for month 1. The separate month 1 parameters are used since the first month may be only a partial month; i.e. if this is being run with a start date of the 16^{th} of the month then only a half month's allocation is expected to be remaining—on the 16^{th} you would want a target of 80 hours rather than 160 hours and your parameters might be, for example, 70 and 90. The program then highlights those monthly totals which are less than the target minimum or greater than the target maximum. This report enables any project team member to view all tasks assigned to her/him and to see the individual task and combined monthly load.

Selection Options: Summary rows are excluded. Milestones that have no resources assigned are excluded. The user enters the starting date used to determine the twelve months.

Sorting and Grouping: This is grouped by Resource name and sorted within resource by Finish date.

Formatting and Options: Detail tasks with no assigned resources have the resource “Unassigned” generated. The Resource's set of tasks and the total line are expandable/collapsible to show either all details or to show only the total line. The user enters hour quantities to be used for highlighting totals. Hour totals less than the minimum hours parameter are highlighted with one background color, hours greater than the user entered maximum hours parameter are highlighted with a different background color, and hours totals falling between the minimum and maximum are not highlighted. If no highlighting was desired, the user could enter zero for the minimum and a very large number (e.g., 999,999) for the maximum number.

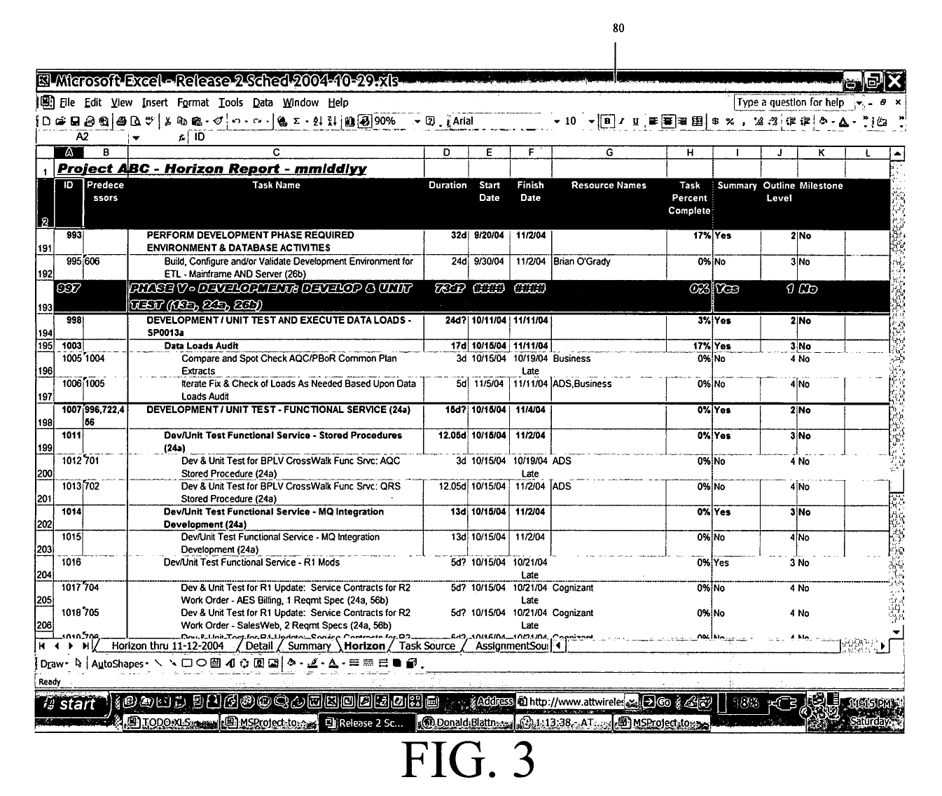

Referring to FIG. 3, an illustrative horizon report 80 is shown. Report 80 is shown to illustrate various features provided by the present invention. Specifically, the following options are illustrated by FIG. 3.

(1) The title prefix “Project ABC” and suffix “mm/dd/yy” are entered by the user at the user prompts, and then used for generation of all reports in a single session. The title middle is typically the report name plus the word “Report” (e.g., “Horizon Report” or “Summary Report”);

(2) The “Rows Repeat” parameter is set to include the Report and Column Headings on every page (and the Freeze Panes option is set to do the same).

(3) Regardless of the sequence of data in the data map and thus in the export file, this routine will sequence the columns in the order as shown here. An order is specified for each of the reports.

(4) Bolding of Summary activities and indenting based on Outline Level are automatically applied to all tasks.

(5) Report 80 was run for a status report meeting on Tuesday 11/2/2004. The limiting date was set to 11/12/2004—to include all past due tasks, tasks from the current week, and tasks from one week beyond the current week. Note that no completed tasks are included and no detail tasks beyond this date (note the missing Task ID numbers indicating excluded tasks—e.g., 994, 996, 999-1002).

(6) In generating report 80, a Horizon period of all past dates through 10/29/2004 was selected and these tasks are background highlighted yellow as per the user response to the dialog screen that provides this control. The default text “Late” was selected to be appended to the tasks with Finish date less than or equal to this date.

(7) There is an option to provide a page break on instances of tasks at Outline Level=1, but this was not used for report 80 of FIG. 3.

(8) The option to provide formatting to Outline Level=1 tasks was selected and a blue background was chosen (this shade of blue works well if the report is printed in black or in color). The Arial Black font style and a larger font size were selected—note that this resulted in the default column widths not working for these rows. In this case the user can regenerate the report and not choose a larger font size or the user can work directly with the worksheet to alter the column width.

(9) The option to put a border above Outline Level=2 was used, but the option to highlight Outline Level 2 tasks was not used.

(10) Note columns to the right of the “Task Percent Complete” column. These are columns that are used in making report generation decisions and other data columns defined in the exporting data mapping. The report is automatically sized to exclude these when printing until after the intended columns are all printed (printing is in a down first, across second sequence).

IV. Computerized Implementation

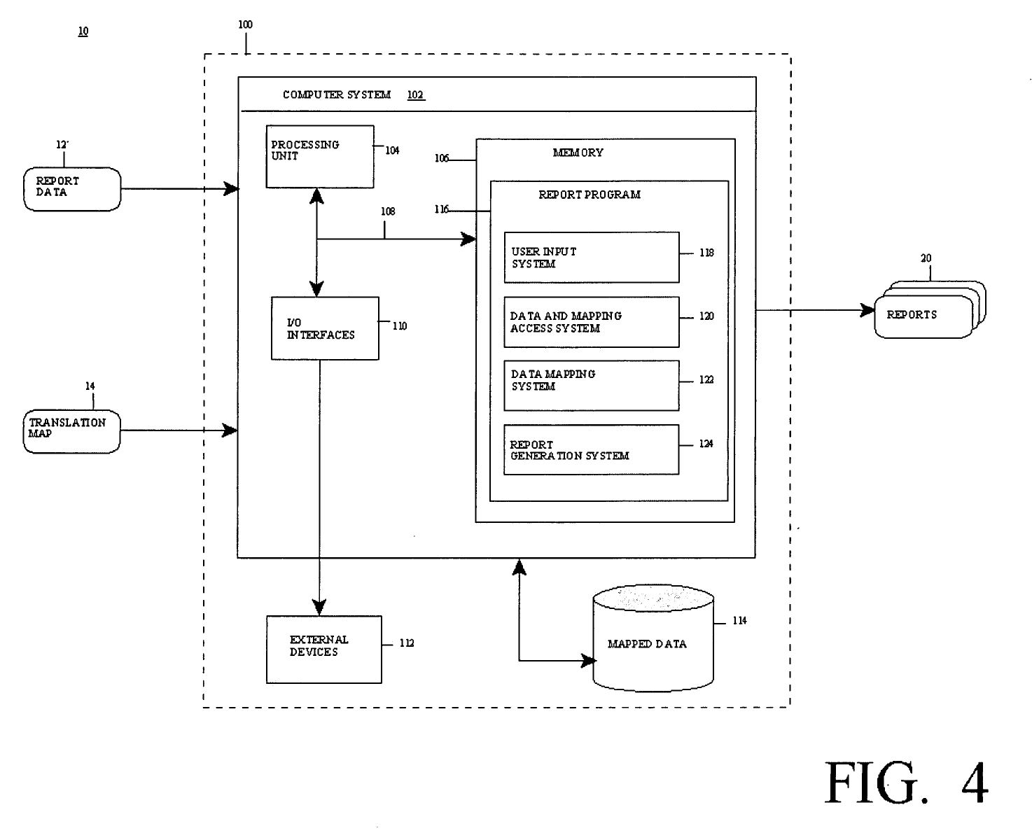

Referring now to FIG. 4, a more specific computerized implementation of the present invention is shown. As depicted in FIG. 4, system 10 includes a computer system 102 deployed within a computer infrastructure 100. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Computer infrastructure 100 is intended to demonstrate that some or all of the components of system 10 could be deployed, managed, serviced, etc. by a service provider who offers to automatically generate reports 20.

As shown, computer system 102 includes a processing unit 104, a memory 106, a bus 108, and input/output (I/O) interfaces 110. Further, computer system 102 is shown in communication with external I/O devices/resources 112 and storage system 114. In general, processing unit 104 executes computer program code, such as report program 116, which is stored in memory 106 and/or storage system 114. While executing computer program code, processing unit 104 can read and/or write data to/from memory 106, storage system 114, and/or I/O interfaces 110. Bus 108 provides a communication link between each of the components in computer system 102. External devices 112 can comprise any devices (e.g., keyboard, pointing device, display, etc.) that enable a user to interact with computer system 102 and/or any devices (e.g., network card, modem, etc.) that enable computer system 102 to communicate with one or more other computing devices.

Computer infrastructure 100 is only illustrative of various types of computer infrastructures for implementing the invention. For example, in one embodiment, computer infrastructure 100 comprises two or more computing devices (e.g., a server cluster) that communicate over a network to perform the various process steps of the invention. Moreover, computer system 102 is only representative of various possible computer systems that can include numerous combinations of hardware. To this extent, in other embodiments, computer system 102 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 104 may comprise a single processing unit, or be distributed across one or more processing units in one or more locations, e.g., on a client and server. Similarly, memory 106 and/or storage system 114 can comprise any combination of various types of data storage and/or transmission media that reside at one or more physical locations. Further, I/O interfaces 110 can comprise any system for exchanging information with one or more external devices 112. Still further, it is understood that one or more additional components (e.g., system software, math co-processing unit, etc.) not shown in FIG. 1 can be included in computer system 102. However, if computer system 102 comprises a handheld device or the like, it is understood that one or more external devices 112 (e.g., a display) and/or storage system(s) 114 could be contained within computer system 102, not externally as shown.

Storage system 114 can be any type of system (e.g., a database) capable of providing storage for information under the present invention, such as data translation maps, mapped data, reports, dialog input, etc. To this extent, storage system 114 could include one or more storage devices, such as a magnetic disk drive or an optical disk drive. In another embodiment, storage system 114 includes data distributed across, for example, a local area network (LAN), wide area network (WAN) or a storage area network (SAN) (not shown). Although not shown, additional components, such as cache memory, communication systems, system software, etc., may be incorporated into computer system 102.

Shown in memory 106 of computer system 102 is report program 116, which is a software program providing the features of the present invention as discussed herein. As shown, report program 116 includes user input system 118, data and mapping access system 120, data mapping system 122 and report generation system 124. In general, user input system 118 provides any interfaces and dialog screens used to provide user input. Data and mapping access system 120 receives, obtains or otherwise accesses report data 12 and data translation map 14. Once accessed, data mapping system 122 will map the report data 12 to yield mapped data in a spreadsheet format. Thereafter, report generation system 124 will generate reports 20 as selected by the user. In generating reports 20, report generation system 124 will perform any formatting, formatting, filtering, etc., based on user dialog input and/or hard coding.

While shown and described herein as a method and system for automatically generating reports, it is understood that the invention further provides various alternative embodiments. For example, in one embodiment, the invention provides a computer-readable/useable medium that includes computer program code to enable a computer infrastructure to automatically generate reports. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 106 (FIG. 4) and/or storage system 114 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to automatically generate reports. In this case, the service provider can create, maintain, support, etc., a computer infrastructure, such as computer infrastructure 100 (FIG. 4) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for automatically generating reports. In this case, a computer infrastructure, such as computer infrastructure 100 (FIG. 4), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 102 (FIG. 4), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

I claim:

1. A computer-implemented method for automatically generating reports, comprising:
providing a data file that includes report data in a first application format;
mapping the report data into a spreadsheet format using a data translation map; and
generating a set of predefined reports containing the report data in the spreadsheet format based on dialog input from a user.

2. The computer-implemented method of claim 1, wherein the mapping step maps the report data to columns and rows of the spreadsheet format.

3. The computer-implemented method of claim 1, further comprising receiving the dialog input from the user, wherein the dialog input comprises a selection of at least one specific report.

4. The computer-implemented method of claim 3, wherein the dialog input further comprises a filter for filtering the report data.

5. The computer-implemented method of claim 1, wherein the report data comprises data corresponding to tasks and scheduling of the tasks.

6. The computer-implemented method of claim 5, wherein the set of predefined reports include the following:
a summary report identifying the tasks having a priority level specified in the dialog input;
a detail report identifying all of the tasks;
a horizon report identifying the tasks that are incomplete;
a finish report identifying the tasks in a completion date sequence according to the schedule;
an assignment report identifying the tasks according to a resource and the completion date; and
a resource load report identifying a remaining work load in monthly intervals.

7. The computer-implemented method of claim 1, further comprising determining a boundary of the report data, wherein the set of predefined reports do not exceed the boundary.

8. The computer-implemented method of claim 1, further comprising automatically formatting the report data in the set of predefined reports.

9. The computer-implemented method of claim 1, further comprising sorting the report data in the set of predefined reports based upon an attribute entered by the user.

10. A system for automatically generating reports, comprising:
a system for obtaining a data file that includes report data in a first application format;
a system for mapping the report data into a spreadsheet format using a data translation map; and
a system for generating a set of predefined reports containing the report data in the spreadsheet format based on dialog input from a user.

11. The system of claim 10, wherein the system for mapping step maps the report data to columns and rows of the spreadsheet format.

12. The system of claim 10, further comprising a system for receiving the dialog input from the user, wherein the dialog input comprises a selection of at least one specific report.

13. The system of claim 12, wherein the dialog input further comprises a filter for filtering the report data.

14. The system of claim 10, wherein the report data comprises data corresponding to tasks and scheduling of the tasks.

15. The system of claim 14, wherein the set of predefined reports include the following reports:
a summary report identifying the tasks having a priority level specified in the dialog input;
a detail report identifying all of the tasks;
a horizon report identifying the tasks that are incomplete;
a finish report identifying the tasks in a completion date sequence according to the schedule;
an assignment report identifying the tasks according to a resource and the completion date; and
a resource load report identifying a remaining work load in monthly intervals.

16. The system of claim 10, wherein the system for generating determines a boundary of the report data, wherein the set of predefined reports do not exceed the boundary.

17. The system of claim 10, wherein the system for generating automatically formats the report data in the set of predefined reports.

18. The system of claim 10, wherein the system for generating sorts the report data in the set of predefined reports based upon an attribute of the user.

19. A program product stored on a computer readable medium for automatically generating reports, the computer readable medium comprising program code for causing a computer system to perform the following steps:
obtaining a data file that includes report data in a first application format;
mapping the report data into a spreadsheet format using a data translation map; and
generating a set of predefined reports containing the report data in the spreadsheet format based on dialog input from a user.

20. The program product of claim 19, wherein the system for mapping step maps the report data to columns and rows of the spreadsheet format.

21. The program product of claim 19, wherein the computer readable medium further comprises program code for causing the computer system to perform the following steps:
receiving the dialog input from the user, wherein the dialog input comprises a selection of at least one specific report;
determining a boundary of the report data, wherein the set of predefined reports do not exceed the boundary;
automatically formatting the report data in the set of predefined reports; and
sorting the report data in the set of predefined reports based upon an attribute of the user.

22. A method for deploying an application for automatically generating reports, comprising:
providing a computer infrastructure being operable to:
obtain a data file that includes report data in a first application format;
map the report data into a spreadsheet format using a data translation map; and
generate a set of predefined reports containing the report data in the spreadsheet format based on dialog input from a user.

23. The method of claim 22, wherein the system for mapping step maps the report data to columns and rows of the spreadsheet format.

24. The method of claim 22, wherein the computer infrastructure is further operable to:
receive the dialog input from the user, wherein the dialog input comprises a selection of at least one specific report;
determine a boundary of the report data, wherein the set of predefined reports do not exceed the boundary;
automatically format the report data in the set of predefined reports; and
sort the report data in the set of predefined reports based upon an attribute of the user.
